(19) United States
(12) Patent Application Publication
(10) Pub. No.: US 2008/0041902 A1
(43) Pub. Date: Feb. 21, 2008

(54) MOTORCYCLE GOLF BAG CARRIER

(76) Inventor: Troy J. WANCHULAK, Edmonton (CA)

Correspondence Address: DAVIS BUJOLD & Daniels, P.L.L.C., 112 PLEASANT STREET, CONCORD, NH, 03301, US

(21) Appl. No.: 11/834,047

(22) Filed: Aug. 6, 2007

Related U.S. Application Data
(60) Provisional application No. 60/838,058, filed on Aug. 16, 2006.

(30) Foreign Application Priority Data
May 4, 2007 (CA) 2588143

(51) Int. Cl. B62J 7/00

(52) U.S. Cl. 224/440; 224/442; 224/447

(57) ABSTRACT

A motorcycle golf bag carrier includes an upper mounting attached to a motorcycle toward a rear end of a motorcycle, and a lower mounting attached below the upper mounting and toward a front of the motorcycle relative to the upper mounting. An upper golf bag support is provided that has a strap for securing an upper portion of a golf bag to the upper golf bag support. The upper golf bag support being removably mounted on the lower mounting. A lower golf bag support is provided that has a strap for securing a lower portion of the golf bag to the lower golf bag support. The lower golf bag support is removably mounted on the lower mounting, such that a golf bag supported by the upper bag support and the lower bag support is supported in an angular orientation.

### FIELD

The present application relates to a carrier for transporting a golf bag on a motorcycle.

### BACKGROUND

Difficulties are encountered when attempting to transport golf clubs using a motorcycle. U.S. Pat. No. 6,938,806 (James) and U.S. Pat. No. 6,619,522 (Schurr) teach racks that can be mounted on a motorcycle to transport golf clubs.

### SUMMARY

There is provided a motorcycle golf bag carrier, including an upper mounting attached to a motorcycle toward a rear end of a motorcycle, and a lower mounting attached below the upper mounting and toward a front of the motorcycle relative to the upper mounting. An upper golf bag support is provided that has means for securing an upper portion of a golf bag to the upper golf bag support. The upper golf bag support being removably mounted on the upper mounting. A lower golf bag support is provided that has means for securing a lower portion of the golf bag to the lower golf bag support. The lower golf bag support is removably mounted on the lower mounting, such that a golf bag supported by the upper bag support and the lower bag support is supported in an angular orientation.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a motorcycle golf bag carrier carrying a golf bag.

FIG. 2 is a side elevation view of mountings on a motorcycle for the motorcycle golf bag carrier.

FIG. 3 is a side elevation view of a protruding pin.

FIG. 4 is a perspective view of an upper golf bag support.

FIG. 5 is a perspective view if a lower golf bag support.

### DETAILED DESCRIPTION

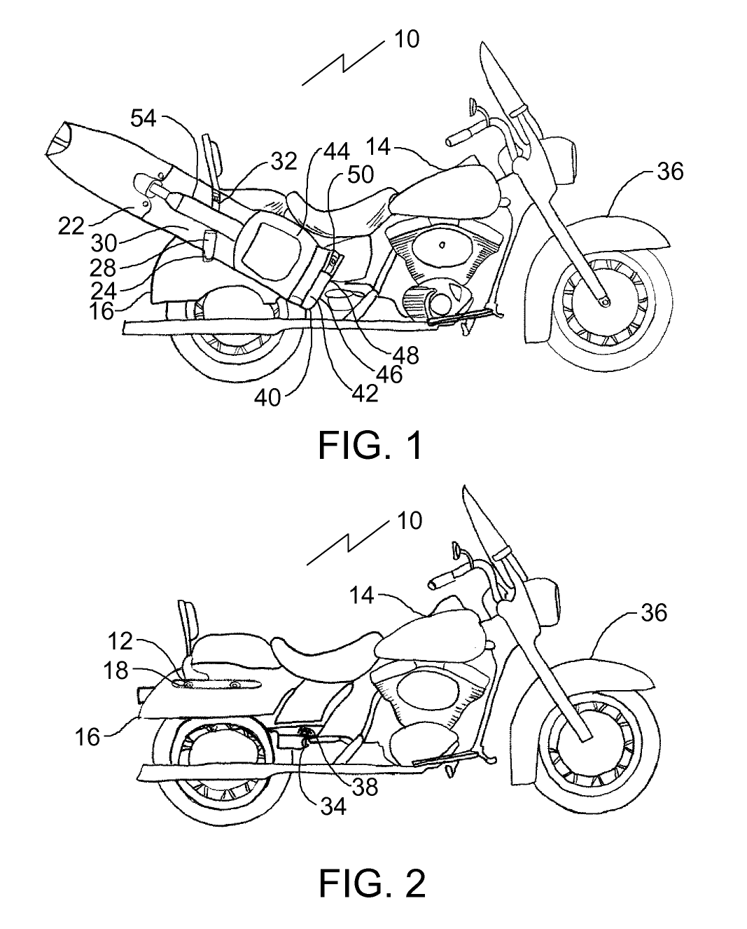

A motorcycle golf bag carrier generally identified by reference numeral 10, will now be described with reference to FIGS. 1 through 5.

Structure and Relationship of Parts:

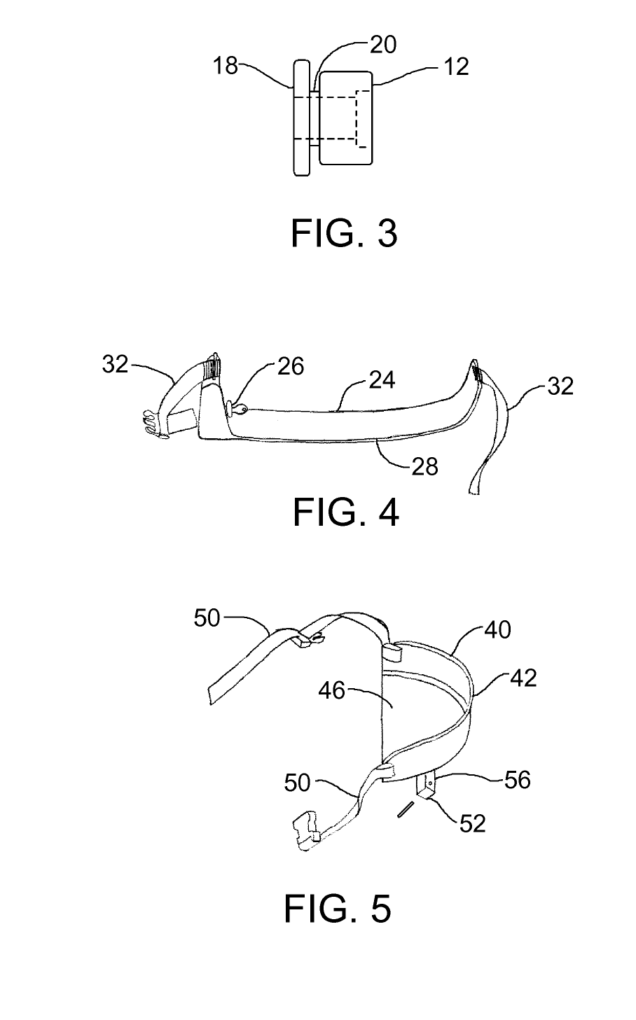

Referring to FIG. 2, motorcycle golf bag carrier 10 includes an upper mounting 12 attached to a motorcycle 14 toward a rear end 16 of motorcycle 14. Referring to FIG. 3, upper mounting 12 is preferably a protruding pin 18 with a locking profile 20. For example, a suitable protruding pin is manufactured for the Easy Brackets™ saddlebag mounting system available at www.easybrackets.com, which is illustrated in FIG. 3. Using the Easy Brackets™ mounting post also has the additional advantage that existing hardware used to support saddlebags can also be used to support a golf bag 22 as shown in FIG. 1. Referring to FIG. 2, to take advantage of existing holes, protruding pin 18 replaces existing fender rail bolts (not shown). Referring to FIG. 1, an upper golf bag support 24 is removably mounted on upper mounting 12 to support the upper portion 30 of golf bag 22. Referring to FIGS. 3 and 4, this is done by placing upper mounting 12 over protruding pin 18, and engaging locking profile 20 using a lock 26. Referring to FIG. 4, upper golf bag support 24 is made from a U-shaped body 28. Referring to FIG. 1, body 28 then receives the upper portion 30 of golf bag 22, which is retained within U-shaped body 28 by an adjustable strap 32.

Referring to FIG. 2, a lower mounting 34 is attached below upper mounting 12 and toward a front 36 of motorcycle 14 relative to upper mounting 12. To take advantage of existing hardware, a passenger foot peg mounting 38 on motorcycle 14 may be used as lower mounting 34 once the foot peg (not shown) has been removed. An additional mounting may be attached if necessary. Referring to FIGS. 1 and 5, a lower golf bag support 40 made up of a U-shaped body 42 for receiving the lower portion 44 of golf bag 22, and an endplate 46 for supporting the bottom 48 of golf bag 22. Lower portion 44 of golf bag 22 is then held in place with lower portion 44 within U-shaped body 42 and for bottom 48 of golf bag 22 held against endplate 46 by an adjustable strap 50. Golf bag 22 may be made more secure by passing strap 32 of upper golf bag support 24 through a handle 54 of golf bag 22. Referring to FIGS. 2 and 5, lower golf bag support 40 is removably mounted on lower mounting 34 by a pin connection 52 to passenger foot peg mounting 38. Pin connection 52 is in a supporting bar 56, which extends under endplate 46. When installed, golf bag 22 is supported by upper bag support 24 and lower bag support 40 in an angular orientation.

Operation:

The use and operation of motorcycle golf bag carrier 10 as described above with reference to FIGS. 1 through 5 will now be discussed. Referring to FIG. 2, motorcycle 14 is modified to carry a golf bag 22 as shown in FIG. 1 by replacing an existing fender rail bolts (not shown) with protruding pin 18 to act as upper mounting 12. Referring to FIG. 2, the passenger foot peg (not shown) is removed from it mounting 38, which then acts as lower mounting 34. Referring to FIGS. 3 and 4, upper golf bag support 24 is mounted by placing upper golf bag support 24 over protruding pin 18, and locking it into place by engaging lock 26 with locking profile 20. Referring to FIGS. 2 and 5, lower golf bag support 40 is mounted by engaging pin connection 52 with passenger foot peg mounting 38. Referring to FIG. 1, once upper golf bag support 24 and lower golf bag support 40 have been mounted onto motorcycle 14, golf bag 22 is supported by them at an angle. Upper portion 30 of golf bag 22 is placed within U-shaped body 28 of upper golf bag support 24 and secured using adjustable strap 32. Lower portion 44 of golf bag 22 is placed within U-shaped body 42 of lower golf bag support 40 with bottom 48 of golf bag 22 against end plate 46, and secured using adjustable strap 50.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A motorcycle golf bag carrier, comprising:
an upper mounting attached to a motorcycle toward a rear end of a motorcycle;
a lower mounting attached below the upper mounting and toward a front of the motorcycle relative to the upper mounting;
an upper golf bag support for supporting an upper portion of a golf bag, the upper golf bag support being removably mounted on the upper mounting; and
a lower golf bag support for supporting a lower portion of the golf bag, the lower golf bag support being removably mounted on the lower mounting, such that a golf bag supported by the upper bag support and the lower bag support is supported in an angular orientation
at least one of the upper golf bag support and the lower golf bag support having means for securing the golf bag to the at least one of the upper golf bag support and the lower golf bag support.

2. The motorcycle golf bag carrier of claim 1, wherein the upper mounting comprises a protruding pin attached to an existing hole, the protruding pin having a locking profile, and the upper golf bag support is releasably mounted on the upper mounting by engaging the locking profile.

3. The motorcycle golf bag carrier of claim 1, wherein the lower mounting comprises a passenger foot peg mounting on the motorcycle, and the lower golf bag support is releasable mounted on the lower mounting by a pin connection to the passenger foot peg mounting.

4. The motorcycle golf bag carrier of claim 1, wherein the upper golf bag support comprises a U-shaped body for receiving the upper portion of the golf bag.

5. The motorcycle golf bag carrier of claim 4, wherein the upper golf bag support has means for securing the upper portion of the golf bag to the upper golf bag support comprising a strap for retaining the upper portion of the golf bag within the U-shaped body.

6. The motorcycle golf bag carrier of claim 1, wherein the lower golf bag support comprises a U-shaped body for receiving the lower portion of the golf bag, and an endplate for supporting a bottom of the golf bag.

7. The motorcycle golf bag carrier of claim 1, wherein the lower golf bag support has means for securing the lower portion of the golf bag to the U-shaped body comprising a strap for securing the lower portion of the golf bag within the U-shaped body and for securing the bottom of the golf bag against the endplate.

8. A motorcycle golf bag carrier, comprising:
an upper mounting attached to a motorcycle toward a rear end of a motorcycle, the upper mounting comprising a protruding pin attached to an existing hole, the protruding pin having a locking profile;
a lower mounting attached below the upper mounting and toward a front of the motorcycle relative to the upper mounting, the lower mounting comprising a passenger foot peg mounting on the motorcycle;
an upper golf bag support comprising a U-shaped body for receiving the upper portion of the golf bag, the upper golf bag support having a strap for retaining the upper portion of the golf bag within the U-shaped body, the upper golf bag support being removably mounted on the upper mounting by engaging the locking profile; and
a lower golf bag support comprising a U-shaped body for receiving the lower portion of the golf bag, and an endplate for supporting a bottom of the golf bag, the lower golf bag support having a strap for securing the lower portion of the golf bag within the U-shaped body and for securing the bottom of the golf bag against the endplate, the lower golf bag support being removably mounted on the lower mounting by a pin connection to the passenger foot peg mounting, such that a golf bag supported by the upper bag support and the lower bag support is supported in an angular orientation.
